(19) United States
(12) Patent Application Publication
(10) Pub. No.: US 2026/0295446 A1
(43) Pub. Date: Oct. 1, 2026

(54) ATTACHMENT DEVICE, INFORMATION PROCESSING SYSTEM, OPERATION METHOD, AND OPERATION PROGRAM

(71) Applicant: Sony Interactive Entertainment Inc., Tokyo (JP)

(72) Inventors: Yumi Ueda, Tokyo (JP); Naoki Kudo, Tokyo (JP); Airi Takeuchi, Tokyo (JP)

(21) Appl. No.: 19/477,432

(22) PCT Filed: Apr. 26, 2023
(86) PCT No.: PCT/JP2023/016536

§ 371 Date: Oct. 21, 2025

(51) Int. Cl. A63F 13/98; A63F 13/53

(52) U.S. Cl. CPC A63F 13/98; A63F 13/53

(57) ABSTRACT

An attachment device (4) includes an attachment unit (41) attached to a controller (3) that includes operation members (37), arms (44, 45) that engage with the operation members, driving units (42, 43) that move the arms, and an action control unit (493) that causes the driving units to drive the arms to operate the operation members.

### TECHNICAL FIELD

The present invention relates to an attachment device, an information processing system, an operation method, and an operation program.

### BACKGROUND ART

An operation device conventionally known is connected to an information processing device, such as a PC (Personal Computer) and a game console, to transmit operation signals to this information processing device (e.g., see PTL 1).

A controller described in PTL 1 (operation device) includes a left holding portion and a right holding portion held by the left and right hands of a user, and direction buttons, operation buttons, and two analog sticks each provided on a front surface of this controller.

### CITATION LIST

### Patent Literature

### PTL 1

U.S. Patent Application Publication No. 2009/0131171

### SUMMARY

### Technical Problem

For example, a user such as a beginner who is unfamiliar with operation of the controller often masters operation with reference to a play video given by an advanced user familiar with operation. However, details of operation are not easily recognizable from the play video given by the advanced user because, in many cases, the hands operating the controller are not visible in the replay video, or an operation member of the controller is hidden by the finger.

Moreover, there is a problem that a system help function is generally provided for a purpose of explanation of an operation method or presentation of clues for game strategies, and therefore cannot assist the user in performing operation.

Further, there is a problem that, in a case of a controller having a plurality of operation members, for example, the user can operate only a limited number of the operation members at a time.

The present invention has been developed to solve at least one of the above-mentioned problems. One of objects of the present invention is to provide an attachment device, an information processing system, an operation method, and an operation program which are capable of assisting a user in performing operation, for example.

### Solution to Problem

An attachment device according to a first aspect of the present invention includes an attachment unit attached to a controller that includes an operation member, an arm that engages with the operation member, a driving unit that moves the arm, and an action control unit that causes the driving unit to drive the arm to operate the operation member.

An information processing system according to a second aspect of the present invention includes a controller that includes an operation member, the attachment device according to the above first aspect attached to the controller, and an information processing device that controls the attachment device. The information processing device includes a transmission unit that transmits operation information associated with operation of the operation member to the attachment device, and a display control unit that forms an image indicating details of operation performed for the operation member on the basis of the operation information.

An operation method according to a third aspect of the present invention is performed by an attachment device to operate an operation member. The attachment device includes an attachment unit attached to a controller including the operation member, an arm that engages with the operation member, and a driving unit that moves the arm. The method includes a reception procedure of receiving operation information from an external device, and an operation procedure of actuating the driving unit on the basis of the received operation information to operate the operation member engaging with the arm.

An operation method according to a fourth aspect of the resent invention is performed by an attachment device to operate an operation member. The attachment device includes an attachment unit attached to a controller including the operation member, an arm that engages with the operation member, and a driving unit that moves the arm. The method includes a reading procedure of reading, from a storage unit, operation information that indicates details of operation of the operation member and is stored in the storage unit beforehand, and an operation procedure of actuating the driving unit on the basis of the read operation information to operate the operation member engaging with the arm.

An operation program according to a fifth aspect of the present invention is executed by a control unit of an attachment device to operate an operation member. The attachment device includes an attachment unit attached to a controller including the operation member, an arm that engages with the operation member, a driving unit that moves the arm, and the control unit that controls the driving unit. The operation program causes the control unit to execute a reception step of receiving operation information from an external device, and an operation step of actuating the driving unit on the basis of the received operation information to operate the operation member engaging with the arm.

An operation program according to a sixth aspect of the present invention is executed by a control unit of an attachment device to operate an operation member. The attachment device includes an attachment unit attached to a controller including the operation member, an arm that engages with the operation member, a driving unit that moves the arm, and the control unit that controls the driving unit. The operation program causing the control unit to execute a read step of reading, from a storage unit, operation information that indicates details of operation of the operation member and is stored in the storage unit beforehand, and an operation step of actuating the driving unit on the basis of the read operation information to operate the operation member engaging with the arm.

### BRIEF DESCRIPTION OF DRAWINGS

FIG. 1 is a schematic view illustrating a configuration of an information processing system according to a first embodiment.

FIG. 2 is a front view illustrating a controller according to the first embodiment.

FIG. 3 is a block diagram illustrating another configuration of the controller according to the first embodiment.

FIG. 4 is a front view illustrating an attachment device according to the first embodiment.

FIG. 5 is a perspective view illustrating the attachment device according to the first embodiment.

FIG. 6 is a perspective view illustrating the attachment device according to the first embodiment.

FIG. 7 is a view illustrating the attachment device in a state attached to the controller according to the first embodiment.

FIG. 8 is a view illustrating the attachment device from which a second housing has been removed according to the first embodiment.

FIG. 9 is an exploded perspective view illustrating the attachment device according to the first embodiment.

FIG. 10 is a block diagram illustrating another configuration of the attachment device according to the first embodiment.

FIG. 11 is a block diagram illustrating a configuration of an information processing device according to the first embodiment.

FIG. 12 is a view illustrating an example of a replay screen according to the first embodiment.

FIG. 13 is a view illustrating an enlarged second display region according to the first embodiment.

FIG. 14 is a flowchart illustrating a replay video replaying process performed by the information processing device, and an operation process performed by the attachment device, according to the first embodiment.

FIG. 15 is a front view illustrating the attachment device to which a function extension device has been attached according to the first embodiment.

FIG. 16 is a front view illustrating the attachment device to which cover members have been attached according to the first embodiment.

FIG. 17 is a block diagram illustrating an attachment device of an information processing system according to a second embodiment.

FIG. 18 is a flowchart illustrating an operation process performed by the attachment device according to the second embodiment.

### DESCRIPTION OF EMBODIMENTS

### First Embodiment

A first embodiment of the present invention will hereinafter be described with reference to the drawings.

### Outline Configuration of Information Processing System

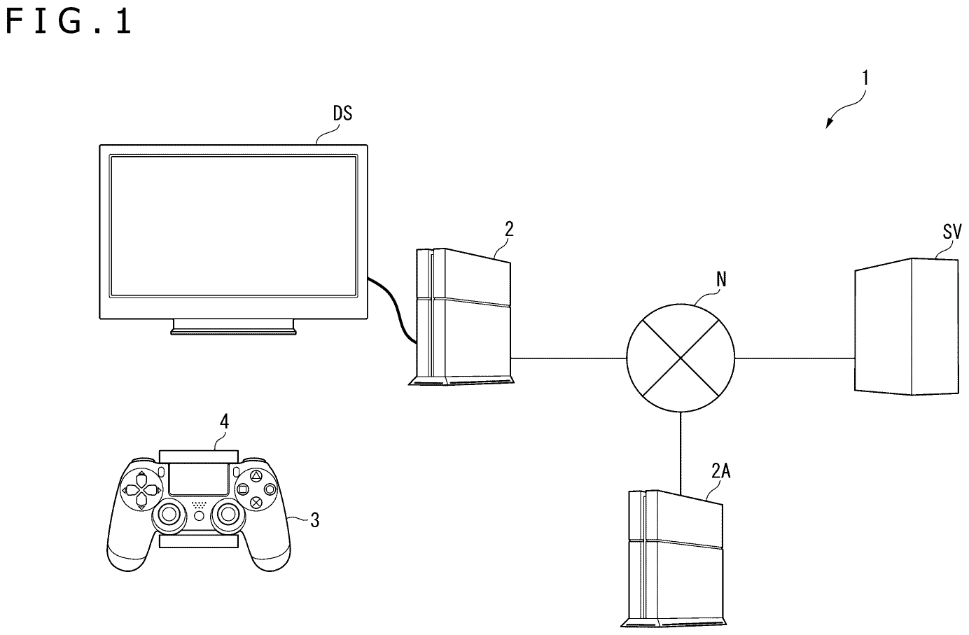

FIG. 1 is a schematic view illustrating a configuration of an information processing system 1 according to the present embodiment.

As illustrated in FIG. 1, the information processing system 1 according to the present embodiment includes an information processing device 2, a controller 3, and an attachment device 4. In the information processing system 1, the attachment device 4 is attached to the controller 3 during use, and operates operation members provided on the controller 3 on the basis of control information transmitted from the information processing device 2. A configuration of the information processing system 1 will hereinafter be described in detail.

### Outline Configuration of Information Processing Device

The information processing device 2 communicates with the controller 3 and the attachment device 4. In addition, the information processing device 2 is configured to be connectable with a network N, such as the Internet, and communicate with a server SV and another information processing device 2A connected with the network N. The information processing device 2 executes various types of processing according to operation signals received from the controller 3, and outputs images indicating execution results to a display device DS. For example, the information processing device 2 causes a game to progress according to received operation signals, and displays a game screen, during execution, on the display device DS.

Moreover, the information processing device 2 transmits control information to the attachment device 4, and operates the operation members of the controller 3 by using the attachment device 4. A configuration of the information processing device 2 will be described below in detail.

### Configuration of Controller

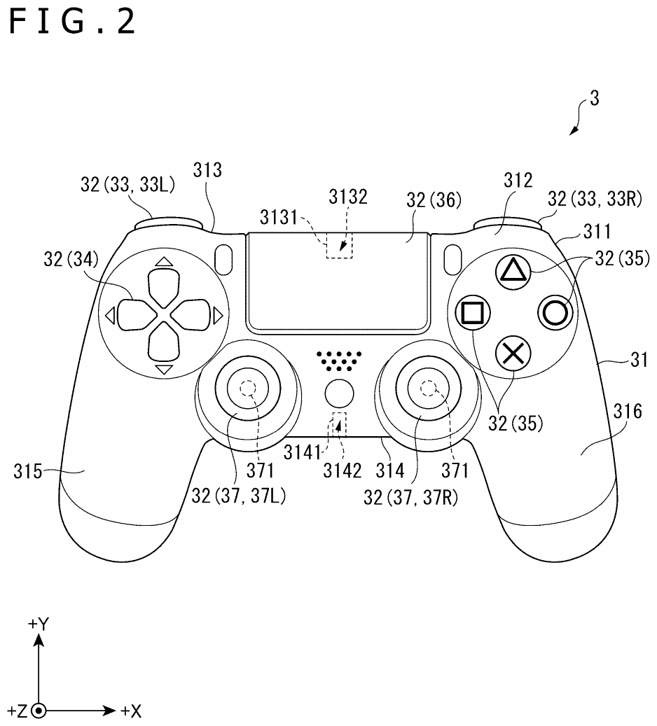

FIG. 2 is a front view illustrating the controller 3. The controller 3 transmits to the information processing device 2 operation signals corresponding to input operation from a user to operate the information processing device 2. As illustrated in FIG. 2, the controller 3 includes a housing 31 and an operation unit 32.

In the following description, a +X direction, a +Y direction, and a +Z direction will be defined as three directions orthogonal to each other. Specifically, a right direction, an upward direction, and a front direction as viewed from a position facing the controller 3 will be referred to as the +X direction, the +Y direction, and the +Z direction, respectively. In other words, a right direction and an upward direction as viewed in FIG. 2 will be referred to as the +X direction and the +Y direction, respectively, and a rising direction from a sheet surface of FIG. 2 will be referred to as the +Z direction. While not illustrated in the figure, directions opposite to the +X direction, the +Y direction, and the +Z direction will be referred to as a −X direction, a −Y direction, and a −Z direction, respectively. In addition, axes extending along the +X direction, the +Y direction, and the +Z direction will be referred to as an X axis, a Y axis, and a Z axis, respectively.

### Configuration of Housing

The housing 31 includes a housing main body 311, a left grip 315, and a right grip 316.

The housing main body 311 houses a communication unit and a control unit included in the controller 3 and will be described below. The housing main body 311 has a front portion 312, a top portion 313, and a bottom portion 314, and also a not-illustrated back portion.

The front portion 312 is a surface included in the housing main body 311 and facing in the +Z direction. A part of the operation unit 32 is provided on the front portion 312.

The top portion 313 is a surface included in the housing main body 311 and facing in the +Y direction. Buttons 33 included in the operation unit 32 and will be described below are provided on the top portion 313. In addition, a recess portion 3131 is formed in the top portion 313, and a terminal 3132 is provided inside the recess portion 3131. The terminal 3132 constitutes one terminal on the controller side.

The bottom portion 314 is a surface included in the housing main body 311 and facing in the −Y direction. A recess portion 3141 is formed in the bottom portion 314, and a terminal 3142 is provided inside the recess portion 3141. The terminal 3142 constitutes one terminal on the controller side.

The back portion is a surface included in the housing main body 311 and facing in the −Z direction.

The left grip 315 has a substantially cylindrical shape, and protrudes in the −X direction and the −Y direction from the −X side end of the housing main body 311. The left grip 315 constitutes one of the grips, and is held by the left hand of the user.

The right grip 316 has a substantially cylindrical shape, and protrudes in the +X direction and the −Y direction from the +X side end of the housing main body 311. The right grip 316 constitutes the other of the grips, and is held by the right hand of the user.

### Configuration of Operation Unit

The operation unit 32 includes a plurality of operation members provided on the housing 31. The operation unit 32 includes the two buttons 33, one-direction buttons 34, four buttons 35, a touch pad 36, and two sticks 37. Each of these components corresponds to an operation member according to the present invention.

A button 33L which is one of the two buttons 33 is disposed in a −X side region of the top portion 313, while the other button 33R is disposed in a +X side region of the top portion 313.

The direction buttons 34, the buttons 35, the touch pad 36, and the sticks 37 are provided on the front portion 312.

The direction buttons 34 are buttons allowed to be pressed in the ±X direction and the ±Y direction. The direction buttons 34 are disposed in a −X side region of the front portion 312.

Each of the four buttons 35 is a button allowed to be individually pressed. The four buttons 35 are disposed in a +X side region of the front portion 312.

The touch pad 36 is a two-point detection type touch pad, and is disposed on the front portion 312 between the direction buttons 34 and the four buttons 35.

A first stick 37L which is one of the two sticks 37 is disposed on the −X side and the −Y side of the touch pad 36, while a second stick 37R is disposed on the +X side and the −Y side of the touch pad 36.

Each of the sticks 37L and 37R has a shaft portion 371 tiltable with respect to the front portion 312. Each of the sticks 37L and 37R detects a tilt direction and a tilt amount input to the shaft portion 371 from the user, and outputs signals indicating the tilt direction and the tilt amount thus detected.

### Another Configuration of Controller

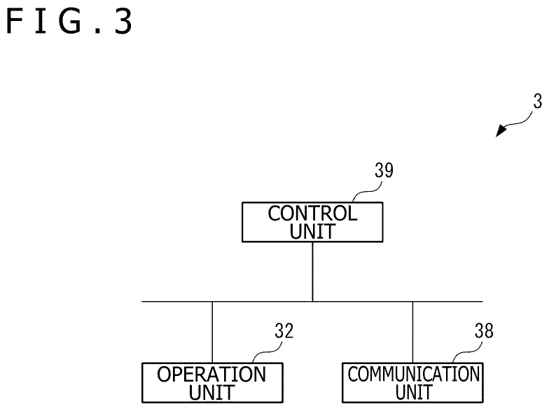

FIG. 3 is a block diagram illustrating another configuration of the controller 3.

As illustrated in FIG. 3, the controller 3 further includes a communication unit 38 and a control unit 39. While not illustrated in the figure, the controller 3 further includes a power source unit which supplies power for actuating the controller 3.

The communication unit 38 communicably connects with an external device under control by the control unit 39. For example, the communication unit 38 communicates with the information processing device 2 wirelessly or by wire. Moreover, for example, the communication unit 38 is communicable with an external device connected with the terminal 3132.

The control unit 39 controls actions of the controller 3. For example, the control unit 39 generates operation signals corresponding to operation input to the operation unit 32 from the user, and transmits the operation signals to the information processing device 2 by using the communication unit 38.

### Configuration of Attachment Device

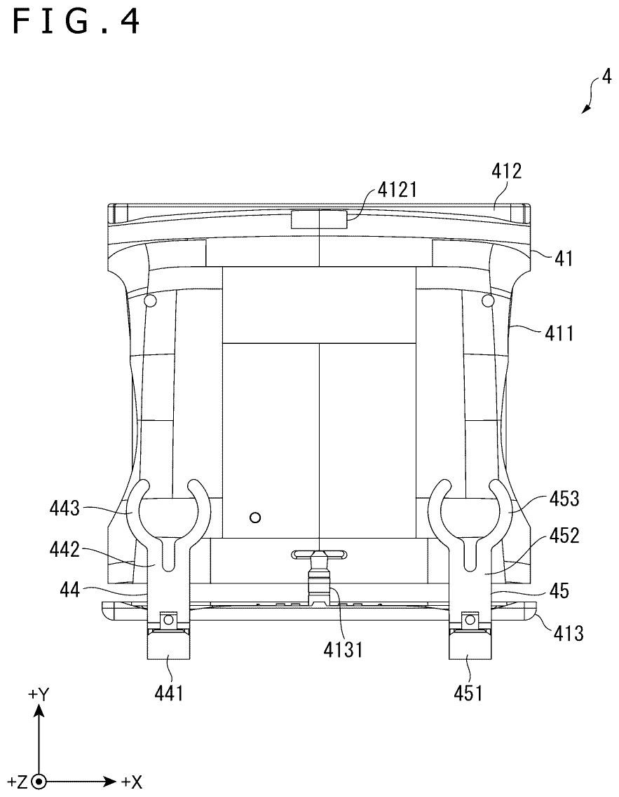

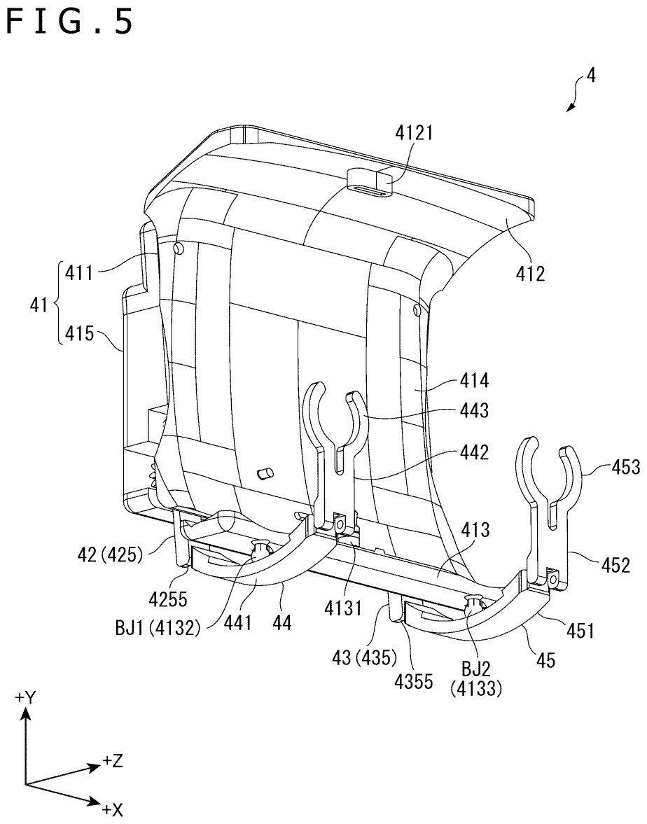

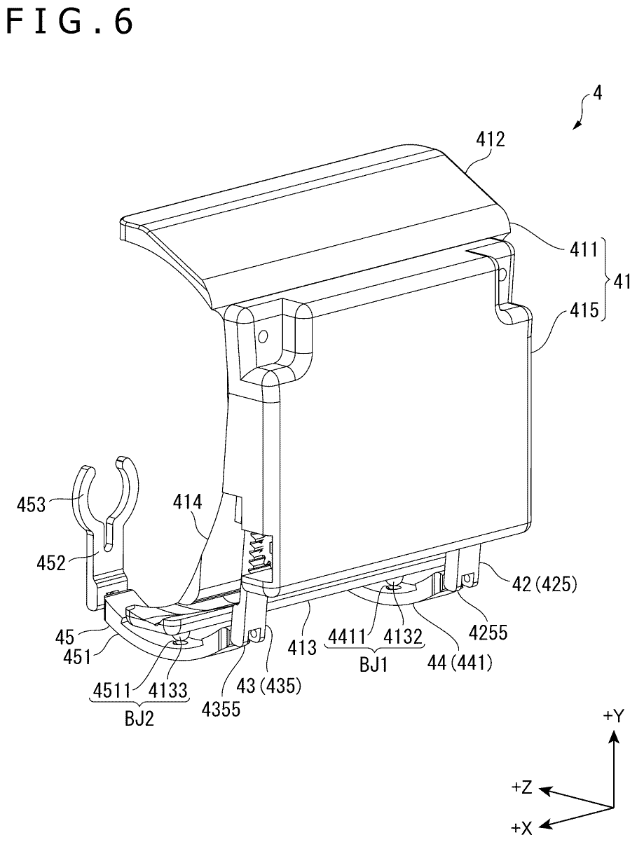

FIG. 4 is a front view illustrating the attachment device 4. FIG. 5 is a perspective view illustrating the attachment device 4 viewed from the front side, while FIG. 6 is a perspective view illustrating the attachment device 4 viewed from the back side.

The attachment device 4 attached to the controller 3 operates at least one of the operation members provided on the controller 3. As illustrated in FIGS. 4 to 6, the attachment device 4 includes an attachment unit 41, a first arm 44, and a second arm 45.

### Configuration of Attachment Unit

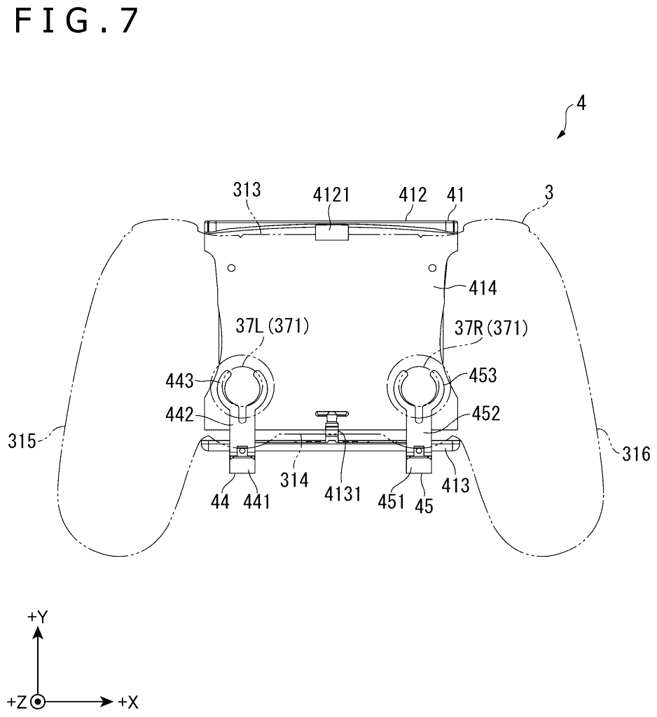

FIG. 7 is a view illustrating the attachment device 4 in a state attached to the controller 3.

As illustrated in FIGS. 5 and 6, the attachment unit 41 has a substantially U shape laid down and open in the +Z direction as viewed in the +X direction. As illustrated in FIG. 7, the attachment unit 41 is attached to the controller 3 in such a manner as to cover the top portion 313, the bottom portion 314, and the back portion of the controller 3. As illustrated in FIGS. 5 to 6, the attachment unit 41 includes a first housing 411 and a second housing 415.

The second housing 415 constitutes the back of the attachment device 4. The second housing 415 is attached to the first housing 411 and covers a support portion 414 of the first housing 411 in the −Z direction.

The first housing 411 is a portion which holds the controller 3 to attach the attachment device 4 to the controller 3. The first housing 411 includes a first pinching portion 412, a second pinching portion 413, and the support portion 414.

The first pinching portion 412 is disposed on the +Y side of the top portion 313 and comes into contact with the top portion 313. The second pinching portion 413 is disposed on the −Y side of the bottom portion 314 and comes into contact with the bottom portion 314. The first pinching portion 412 and the second pinching portion 413 pinch the housing main body 311 in the +Y direction and the −Y direction in a state of contact between a +Z side surface of the support portion 414 and the back portion of the housing 31. In this manner, the attachment device 4 is attached to the controller 3.

The first pinching portion 412 has a connection terminal 4121 which protrudes in the −Y direction from a −Y side surface of the first pinching portion 412. The connection terminal 4121 is an insertion portion inserted into the recess portion 3131 formed in the top portion 313, and is connected with the terminal 3132 provided inside the recess portion 3131.

The second pinching portion 413 has a connection terminal 4131 which protrudes in the +Y direction from a +Y side surface of the second pinching portion 413. The connection terminal 4131 is an insertion portion inserted into the recess portion 3141 formed in the bottom portion 314, and is connected with the terminal 3142 provided inside the recess portion 3141.

The second pinching portion 413 has spherical portions 4132 and 4133 provided on the −Y side surface of the second pinching portion 413. In other words, the attachment unit 41 has the spherical portions 4132 and 4133. The first spherical portion 4132 is a spherical portion provided on a −X side portion of the second pinching portion 413, while the second spherical portion 4133 is a spherical portion provided on a +X side portion of the second pinching portion 413. The first spherical portion 4132 comes into contact with a first recess portion 4411 described below and formed in the first arm 44, while the second spherical portion 4133 comes into contact with a second recess portion 4511 described below and formed in the second arm 45. In this configuration, the first spherical portion 4132 and the first recess portion 4411 constitute a first spherical joint BJ1, and the second spherical portion 4133 and the second recess portion 4511 constitute a second spherical joint BJ2.

The support portion 414 is disposed along the back portion of the controller 3. A −Z side surface of the support portion 414 supports a first driving unit 42 and a second driving unit 43 each described below. The driving units 42 and 43 supported by the support portion 414 are covered by the second housing 415.

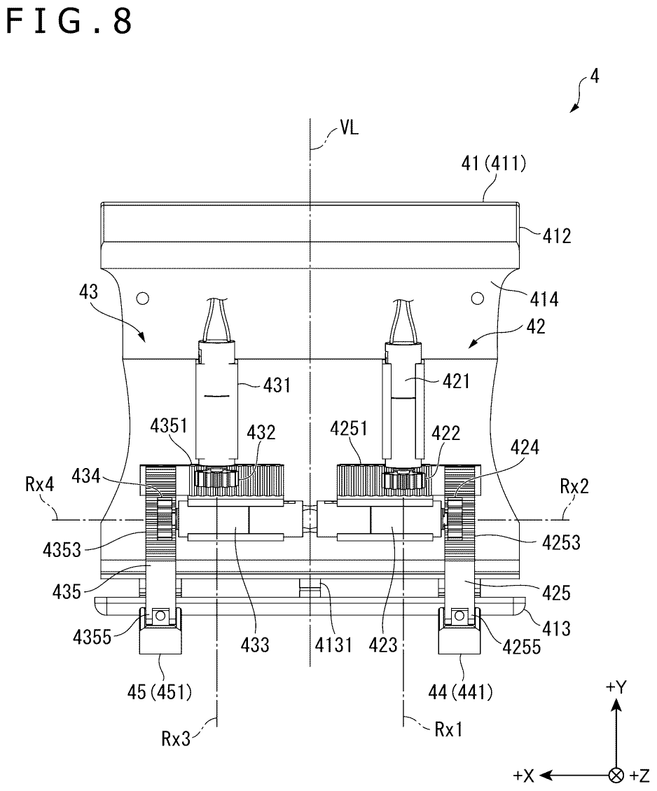

FIG. 8 is a view illustrating a state of the attachment device 4 from which the second housing 415 has been removed as viewed in the −Z direction.

The attachment device 4 includes the attachment unit 41, the first arm 44, and the second arm 45, and further includes the first driving unit 42 and the second driving unit 43 as illustrated in FIG. 8.

### Configuration of First Driving Unit

The first driving unit 42 operates the first arm 44 under control by a control unit 49 described below. The first driving unit 42 includes a first motor 421, a second motor 423, and a first rack 425.

The first motor 421 swings the first arm 44 with a fulcrum located at the first spherical portion 4132, and around a rotation axis extending along the Y axis. The first motor 421 has a first pinion 422 engaging with the first rack 425. The first motor 421 moves the first rack 425 in the IX direction by rotating the first pinion 422 around a first rotation axis Rx1 extending along the Y axis.

The second motor 423 swings the first arm 44 with a fulcrum located at the first spherical portion 4132, and around a rotation axis extending along the X axis. The second motor 423 has a second pinion 424 engaging with the first rack 425. The second motor 423 moves a second engaging portion 4253, which is formed in the first rack 425 and will be described below, in the ±Y direction by rotating the second pinion 424 around a second rotation axis Rx2 extending along the X axis.

The first rack 425 is moved in the ±X direction and the ±Y direction by the first motor 421 and the second motor 423. The first rack 425 has a first engaging portion 4251 and the second engaging portion 4253. The first rack 425 constituted by a combination of the first engaging portion 4251 and the second engaging portion 4253 has an L shape rotated clockwise by 180 degrees as viewed in the −Z direction.

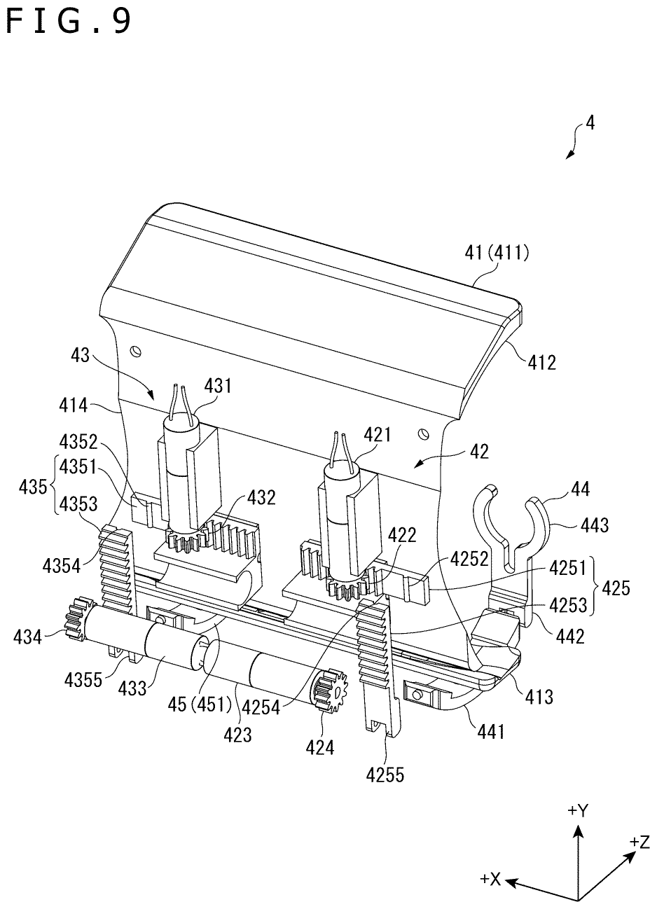

FIG. 9 is a perspective view illustrating the first rack 425 in a disconnected state between the first engaging portion 4251 and the second engaging portion 4253.

The first engaging portion 4251 extends along the X axis. The first engaging portion 4251 has a plurality of teeth engaging with the first pinion 422. The plurality of teeth extend along the Y axis, and reside side by side along the X axis. Accordingly, when the first pinion 422 is rotated by the first motor 421, the first rack 425 shifts in the +X direction or the −X direction.

As illustrated in FIG. 9, the first engaging portion 4251 has a first protrusion portion 4252 formed on the −Z side of the first engaging portion 4251 and protruding in the −Z direction. The first protrusion portion 4252 is provided at an −X side end of the first engaging portion 4251 along the Y axis.

The second engaging portion 4253 extends along the Y axis. A part of the second engaging portion 4253 overlaps with the −X side end of the first engaging portion 4251. The second engaging portion 4253 has a plurality of teeth engaging with the second pinion 424. The plurality of teeth each extend along the X axis, and reside side by side along the Y axis.

As illustrated in FIG. 9, the second engaging portion 4253 has a first recess portion 4254. The first recess portion 4254 is formed in a +Z side surface of the second engaging portion 4253, and recessed in the −Z direction. The first recess portion 4254 is formed along the Y axis. The first protrusion portion 4252 is inserted into the first recess portion 4254. Accordingly, when the second pinion 424 is rotated by the second motor 423, the first rack 425 moves in the +Y direction or the −Y direction.

Specifically, in a case where the first engaging portion 4251 slides along the X axis by actuation of the first motor 421, the second engaging portion 4253 slides along the X axis together with the first engaging portion 4251. Meanwhile, in a case where the second engaging portion 4253 slides along the Y axis by actuation of the second motor 423, only the second engaging portion 4253 slides along the Y axis, and the first engaging portion 4253 remains stationary. In other words, the second engaging portion 4253 slides along the Y axis independently of the first engaging portion 4251.

As illustrated in FIGS. 8 to 9, the second engaging portion 4253 further includes a first junction portion 4255.

The first junction portion 4255 is provided at a −Y side end of the first rack 425. The first junction portion 4255 is joined to the first arm 44.

### Configuration of Second Driving Unit

Similarly to the first driving unit 42, the second driving unit 43 operates the second arm 45 under control by the control unit 49. The second driving unit 43 is provided on the +X side of the first driving unit 42. The second driving unit 43 includes a third motor 431, a fourth motor 433, and a second rack 435 similar to the first motor 421, the second motor 423, and the first rack 425, respectively. The set of the third motor 431, the fourth motor 433, and the second rack 435, and the set of the first motor 421, the second motor 423, and the first rack 425 are arranged linearly symmetric with respect to a virtual line VL which passes through a center of the support portion 414 in the X-axis direction and extends along the Y axis.

The third motor 431 is disposed on the +X side of the first motor 421, and swings the second arm 45 with a fulcrum located at the second spherical portion 4133, and around a rotation axis extending along the Y axis. The third motor 431 has a third pinion 432 engaging with the second rack 435. The third motor 431 moves the second rack 435 in the ±X direction by rotating the third pinion 432 around a third rotation axis Rx3 extending along the Y axis.

The fourth motor 433 is disposed on the +X side of the second motor 423, and swings the second arm 45 with a fulcrum located at the second spherical portion 4133, and around a rotation axis extending along the X axis. The fourth motor 433 has a fourth pinion 434 engaging with the second rack 435. The fourth motor 433 moves a fourth engaging portion 4353, which is formed in the second rack 435 and described below, in the ±Y direction by rotating the fourth pinion 434 around a fourth rotation axis Rx4 extending along the X axis.

The second rack 435 is moved in the ±X direction and the ±Y direction by the third motor 431 and the fourth motor 433. The second rack 435 has a third engaging portion 4351 and the fourth engaging portion 4353 similar to the first engaging portion 4251 and the second engaging portion 4253. The second rack 435 constituted by a combination of the third engaging portion 4351 and the fourth engaging portion 4353 has an L shape rotated clockwise by 90 degrees as viewed in the −Z direction.

The third engaging portion 4351 extends along the X axis. The third engaging portion 4351 has a plurality of teeth engaging with the third pinion 432. The plurality of teeth extend along the Y axis, and reside side by side along the X axis. Accordingly, when the third pinion 432 is rotated by the third motor 431, the second rack 435 shifts in the +X direction or the −X direction.

As illustrated in FIG. 9, the third engaging portion 4351 has a second protrusion portion 4352 which is formed at a +X side end of the surface facing in the −Z direction, and is similar to the first engaging portion 4251. The first protrusion portion 4252 protrudes in the −Z direction, and extends along the Y axis.

The fourth engaging portion 4353 extends in the −Y direction from a +X side end of the third engaging portion 4351. The fourth engaging portion 4353 has a plurality of teeth engaging with the fourth pinion 434. The plurality of teeth extend along the X axis, and reside side by side along the Y axis.

As illustrated in FIG. 9, the fourth engaging portion 4353 has a second recess portion 4354. The second recess portion 4354 is formed in a +Z side surface of the fourth engaging portion 4353, and recessed in the −Z direction. The second recess portion 4354 is formed along the Y axis. The second protrusion portion 4352 is inserted into the second recess portion 4354. Accordingly, when the fourth pinion 434 is rotated by the fourth motor 433, the second rack 435 shifts in the +Y direction or the −Y direction.

Specifically, in a case where the third engaging portion 4351 slides along the X axis by actuation of the third motor 431, the fourth engaging portion 4353 slides along the X axis together with the third engaging portion 4351. Meanwhile, in a case where the fourth engaging portion 4353 slides along the Y axis by actuation of the fourth motor 433, only the fourth engaging portion 4353 slides along the Y axis, and the third engaging portion 4351 remains stationary. Accordingly, the fourth engaging portion 4353 slides along the Y axis independently of the third engaging portion 4351.

As illustrated in FIGS. 8 to 9, the fourth engaging portion 4353 further includes a second junction portion 4355.

The second junction portion 4355 is provided at a −Y side end of the second rack 435. The second junction portion 4355 is joined to the second arm 45.

### Configuration of First Arm

The first rack 425 and the shaft portion 371 of the first stick 37L are joined to each other by the first arm 44 when the attachment device 4 is attached to the controller 3.

Specifically, as illustrated in FIGS. 5 and 8, the first arm 44 is joined to the first junction portion 4255 of the first rack 425, and extends in the +Z direction from the first junction portion 4255 in a space on the −Y side of the second pinching portion 413. Moreover, as illustrated in FIG. 5, the first arm 44 is bent in the +Y direction and engages with the shaft portion 371 of the first stick 37L.

The first arm 44 thus configured swings around the first spherical portion 4132 according to movement of the first rack 425 in the ±X direction and the ±Y direction. In this manner, the first arm 44 operates the first stick 37L by using the first driving unit 42.

As illustrated in FIGS. 4, 5, and 7, the first arm 44 includes a first extending portion 441, a second extending portion 442, and a first holding portion 443. The first extending portion 441 is joined to the first junction portion 4255 of the first rack 425. The first extending portion 441 extends in the +Z direction from the first junction portion 4255. Specifically, the first extending portion 441 is curved to extend in the −Y direction with nearness to the center in the Z-axis direction from the first junction portion 4255, and further extend in the +Y direction with nearness to a +Z side end from the center in the Z-axis direction. The first extending portion 441 has a first recess portion 4411 formed in a +Y side surface facing the second pinching portion 413. A part of the first spherical portion 4132 is disposed inside the first recess portion 4411. A surface constituting the first recess portion 4411 and coming into contact with the first spherical portion 4132 is a sliding surface. Specifically, the first arm 44 has a sliding surface which comes into contact with the first spherical portion 4132, and relatively slides with respect to the first spherical portion 4132 along the first spherical portion 4132.

Note that the first extending portion 441 is joined to a −Y side end of the first junction portion 4255 in such a manner as to be rotatable around a rotation axis extending along the X axis. However, instead of this configuration, the first extending portion 441 may be formed integrally with the second engaging portion 4253 of the first rack 425.

The second extending portion 442 extends in the +Y direction from a +Z side end of the first extending portion 441. The second extending portion 442 is joined to a +Z side end of the first extending portion 441 in such a manner as to be rotatable around a rotation axis extending along the X axis. However, instead of this configuration, the second extending portion 442 may be formed integrally with the first extending portion 441. The first holding portion 443 is formed in a ring shape and provided at an end of the second extending portion 442 on the side opposite to the portion joined to the first extending portion 441. As illustrated in FIG. 7, the first holding portion 443 holds the shaft portion 371 of the first stick 37L.

The first arm 44 thus configured swings around the first extending portion 441, and also the first spherical portion 4132 by the contact between the first extending portion 441 and the first spherical portion 4132. Specifically, when the first rack 425 is moved in the +X direction by the first motor 421, the first holding portion 443 is moved in the −X direction around a fulcrum located at the first spherical portion 4132. When the first rack 425 is moved in the −X direction by the first motor 421, the first holding portion 443 is moved in the +X direction with a fulcrum located at the first spherical portion 4132. Meanwhile, when the first rack 425 is moved in the +Y direction by the second motor 423, the first holding portion 443 is moved in the −Y direction with a fulcrum located at the first spherical portion 4132. When the first rack 425 is moved in the −Y direction by the second motor 423, the first holding portion 443 is moved in the +Y direction with a fulcrum located at the first spherical portion 4132.

In this manner, the first arm 44 swings around the first spherical portion 4132 according to actuation of the first motor 421 and the second motor 423 to operate the first stick 37L held by the first holding portion 443.

### Configuration of Second Arm

The second rack 435 and the shaft portion 371 of the second stick 37R are joined to each other by the second arm 45 when the attachment device 4 is attached to the controller 3.

Specifically, as illustrated in FIGS. 5 and 8, the second arm 45 is joined to the second junction portion 4355 of the second rack 435, and extends in the +Z direction from the second junction portion 4355 in a space on the −Y side of the second pinching portion 413. Moreover, as illustrated in FIGS. 5 and 6, the second arm 45 is bent in the +Y direction and engages with the shaft portion 371 of the second stick 37R.

The second arm 45 thus configured swings around the second spherical portion 4133 according to movement of the second rack 435 in the ±X direction and the ±Y direction. In this manner, the second arm 45 operates the first stick 37L by using the second driving unit 43.

As illustrated in FIGS. 4 to 6, the second arm 45 includes a third extending portion 451, a fourth extending portion 452, and a second holding portion 453 similar to the first extending portion 441, the second extending portion 442, and the first holding portion 443, respectively.

The third extending portion 451 is joined to the second junction portion 4355 of the second rack 435. The third extending portion 451 extends in the +Z direction from the second junction portion 4355. Specifically, similarly to the first extending portion 441, the third extending portion 451 is curved to extend in the −Y direction with nearness to the center in the Z-axis direction from the second junction portion 4355, and further extend in the +Y direction with nearness to a +Z side end from the center in the Z-axis direction.

The third extending portion 451 has a second recess portion 4511 formed in a +Y side surface facing the second pinching portion 413. A part of the second spherical portion 4133 is disposed inside the second recess portion 4511. A surface constituting the second recess portion 4511 and coming into contact with the second spherical portion 4133 is a sliding surface. Specifically, the second arm 45 has a sliding surface which comes into contact with the second spherical portion 4133, and relatively slides with respect to the second spherical portion 4133 along the second spherical portion 4133.

Note that the third extending portion 451 is joined to a −Y side end of the second junction portion 4355 in such a manner as to be rotatable around a rotation axis extending along the X axis. However, instead of this configuration, the third extending portion 451 may be formed integrally with the fourth engaging portion 4353 of the second rack 435.

The fourth extending portion 452 extends in the +Y direction from a +Z side end of the third extending portion 451. The fourth extending portion 452 is joined to a +Z side end of the third extending portion 451 in such a manner as to be rotatable around a rotation axis extending along the X axis. However, instead of this configuration, the fourth extending portion 452 may be formed integrally with the third extending portion 451. The second holding portion 453 is formed in a ring shape and provided at an end of the fourth extending portion 452 on the side opposite to the portion joined to the third extending portion 451. As illustrated in FIG. 7, the second holding portion 453 holds the shaft portion 371 of the second stick 37R.

The second arm 45 thus configured swings around the third extending portion 451, and also the second spherical portion 4133 by the contact between the third extending portion 451 and the second spherical portion 4133. Specifically, when the second rack 435 is moved in the +X direction by the third motor 431, the second holding portion 453 is moved in the −X direction with a fulcrum located at the second spherical portion 4133. When the second rack 435 is moved in the −X direction by the third motor 431, the second holding portion 453 is moved in the +X direction with a fulcrum located at the second spherical portion 4133. Meanwhile, when the second rack 435 is moved in the +Y direction by the fourth motor 433, the second holding portion 453 moves in the −Y direction around a fulcrum located at the second spherical portion 4133. When the second rack 435 is moved in the −Y direction by the fourth motor 433, the second holding portion 453 is moved in the +Y direction with a fulcrum located at the second spherical portion 4133.

In this manner, the first arm 44 swings around the second spherical portion 4133 according to actuation of the third motor 431 and the fourth motor 433 to operate the second stick 37R held by the second holding portion 453.

### Another Configuration of Attachment Device

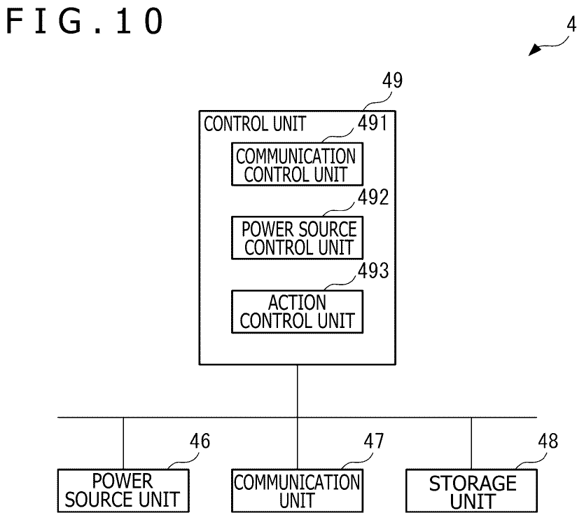

FIG. 10 is a block diagram illustrating another configuration of the attachment device 4.

As illustrated in FIG. 10, the attachment device 4 further includes a power source unit 46, a communication unit 47, a storage unit 48, and a control unit 49.

The power source unit 46 supplies power to electronic parts of the attachment device 4. For example, the power source unit 46 is configured to supply power to the driving units 42 and 43 and the control unit 49, and supply power to the controller 3 via the connection terminal 4121 under control by the control unit 49. The power source unit 46 may be either a primary battery or a secondary battery. The power source unit 46 may be detachably attached to the attachment device 4.

The communication unit 47 communicates with an external device under control by the control unit 49. For example, the communication unit 47 communicates with the information processing device 2 to receive control information from the information processing device 2 and actuate the driving units 42 and 43 on the basis of this control information.

The storage unit 48 stores programs and data required for actions of the attachment device 4. For example, the storage unit 48 stores an operation program read and executed by the control unit 49 to perform an operation process described below.

The control unit 49 includes at least one processor to control actions of the attachment device 4. Specifically, the control unit 49 includes a communication control unit 491, a power source control unit 492, and an action control unit 493.

The communication control unit 491 is configured to communicate with the information processing device 2 via the communication unit 47 and also communicate with the controller 3. For example, the communication control unit 491 acquires control information received from the information processing device 2 via the communication unit 47.

The power source control unit 492 supplies power of the power source unit 46 to the controller 3 via the connection terminal 4121. For example, in a case where power acquired by the communication control unit 491 from a built-in battery of the controller 3 has a value lower than a predetermined value, the power source control unit 492 supplies a part of power received from the power source unit 46 to the controller 3. In this manner, the attachment device 4 can also function as a sub-battery for the controller 3.

The action control unit 493 executes the operation program stored in the storage unit 48 to perform an operation process for actuating the driving units 42 and 43 according to control information acquired by the communication control unit 491. A control process performed by the action control unit 493 will be described below in detail.

### Detailed Configuration of Information Processing Device

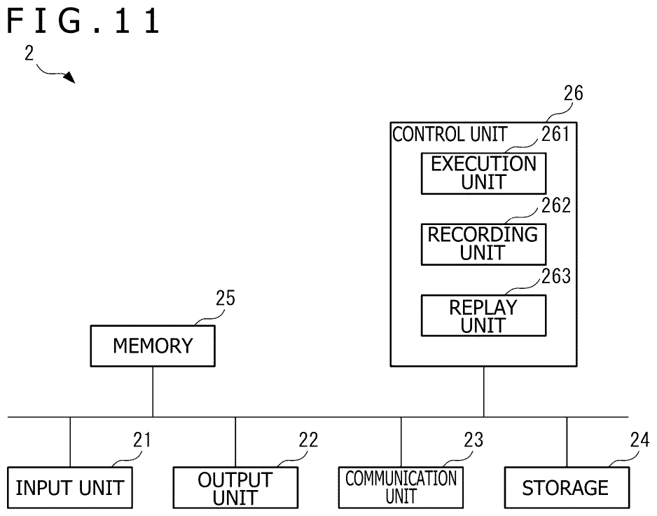

FIG. 11 is a block diagram illustrating a configuration of the information processing device 2.

As illustrated in FIG. 11, the information processing device 2 includes an input unit 21, an output unit 22, a communication unit 23, a storage 24, a memory 25, and a control unit 26.

The input unit 21 has a terminal connectable with an input device by wire. For example, as well as the controller 3, a pointing device and a keyboard are connectable with the input unit 21. The input unit 21 outputs operation signals input from the connected input device to the control unit 26.

The output unit 22 has a terminal connectable with an output device by wire. For example, a display device DS is connected with the output unit 22. The output unit 22 outputs image signals generated by the control unit 26 to the display device DS.

The communication unit 23 wirelessly communicates with an external device under control by the control unit 26. For example, the communication unit 23 wirelessly communicates with the controller 3 and receives operation signals transmitted from the controller 3. Moreover, for example, the communication unit 23 communicates with the attachment device 4 wirelessly or by wire to transmit to the attachment device 4 control information associated with actions of the attachment device 4.

The storage 24 is a storage device such as an HDD (Hard Disk Drive) and an SSD (Solid State Drive), and stores programs and data necessary for actions of the information processing device 2. For example, the storage 24 stores an OS (Operating System) for controlling the information processing device 2, and programs such as a program for a game and a program for operating the attachment device 4.

The memory 25 is a work memory for the control unit 26.

The control unit 26 includes at least one processor, such as a CPU (Central Processing Unit), and executes the programs stored in the storage 24 to control the information processing device 2. The control unit 26 includes an execution unit 261, a recording unit 262, and a replay unit 263.

The execution unit 261 executes programs stored in the storage 24. For example, the execution unit 261 causes a game to progress according to operation signals received from the controller 3, generates a game screen during execution, and outputs the generated screen to the display device DS. In this manner, the execution screen is displayed on the display device DS.

The recording unit 262 records operation signals received from the controller 3 when a recording start signal for recording an operation log is received from the controller 3. Specifically, after reception of the recording start signal, the recording unit 262 records, in the storage 24 in time series, details of operation of operation members performed according to operation signals received from the controller 3. At this time, the control unit 26 may record the execution screen displayed on the display device DS in synchronization with recording of operation signals. Specifically, the recording unit 262 may record a play video of a game together with an operation log indicating details of operation of the operation members. Note that the recording unit 262 ends recording of the operation log in response to reception of a recording stop signal indicating an end operation for the recording of the operation log from the controller 3.

The replay unit 263 performs a replay process for replaying an operation log selected by the user from operation logs recorded in the storage 24 in response to reception of a replay start signal requesting replay of the operation log from the controller 3. Specifically, the replay unit 263 functions as a transmission unit for transmitting to the attachment device 4 control information associated with operation of the operation members of the controller 3 by using the attachment device 4. Moreover, in a case where the user selects the play video recorded together with the operation log, the replay unit 263 transmits control information to the attachment device 4 as well as replay of the replay video.

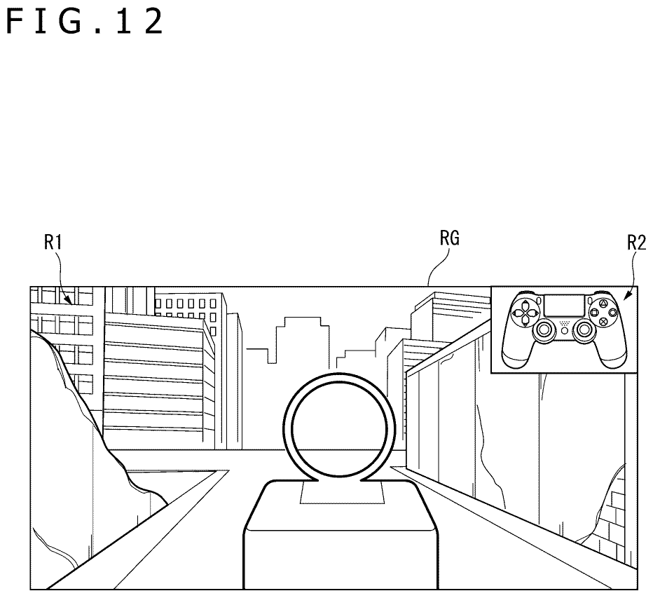

FIG. 12 is a view illustrating an example of a replay screen RG.

For replaying a play video stored in the storage 24 and associated with an operation log, the replay unit 263 forms an image of the replay screen RG which includes a first display region R1 having a rectangular shape, and a second display region R2 having a rectangular shape and displayed with overlap on a part of the first display region R2 as illustrated in FIG. 12, for example.

A replay video replayed by the replay unit 263 is displayed in the first display region R1.

A figure FG1 imitating the controller 3 is displayed in the second display region R2. In addition, details of operation of the controller 3 are displayed in the second display region R2. Specifically, the operated operation member in the operation members of the controller 3, and also details of operation of the operated operation member are displayed. For example, details of operation of the operation member indicated in the recorded operation log are displayed in the second display region R2.

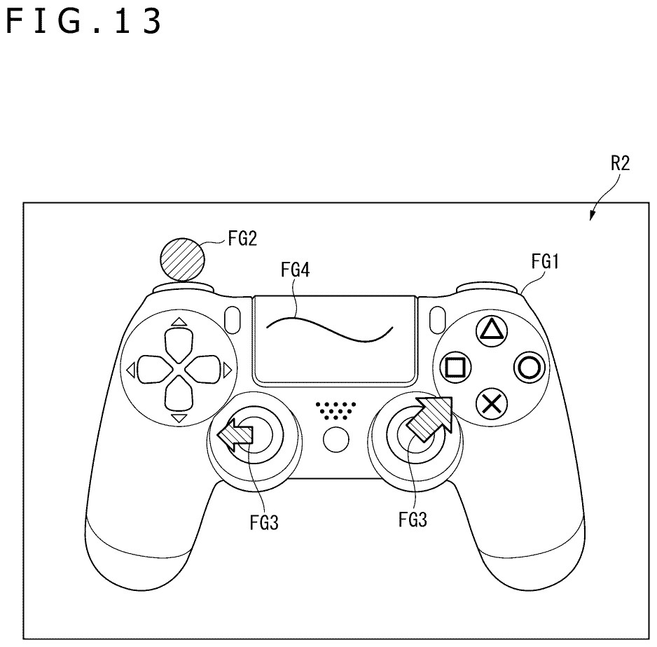

FIG. 13 is a diagram illustrating the enlarged second display region R2.

Specifically, the replay unit 263 displays a predetermined figure FG2 at a position of the corresponding operation member in the figure FG1 to indicate press operation input to one of the buttons 33 to 35 allowed to be pressed, or tap operation input to the touch pad 36 in the operation members constituting the operation unit 32. According to the example in FIG. 13, the figure FG2 is formed at a position corresponding to the button 33L in the figure FG1 to indicate that the button 33L has been pressed. For example, the figure FG2 may be a circle in a first color.

The replay unit 263 displays predetermined figures at the positions corresponding to the sticks 37 in the figure FG1 to indicate tilt operation input to the sticks 37 which are tiltable members in the operation members constituting the operation unit 32. Specifically, the replay unit 263 displays figures FG3 to indicate tilt directions of the sticks 37. For example, the figures FG3 may be arrows in a second color. Note that the replay unit 263 may indicate tilt amounts of the sticks 37 according to sizes of the figures FG3, or tints of the second color set for the figures FG3. For example, as illustrated in FIG. 12, a size of the figure FG3 may be made larger as the tilt amounts of the sticks 37 increase, or the second color may be darkened as the tilt amounts of the sticks 37 increase. In this manner, the tilt amounts of the sticks 37 are recognizable.

The replay unit 263 draws a line FG4 in a third color, for example, at a position corresponding to the touch pad 36 in the figure FG1 to indicate swipe operation input to the touch pad 36 in the operation members constituting the operation unit 32.

As apparent from above, the replay unit 263 functions as a display control unit which forms an image indicating details of operation of the operation member corresponding to control information transmitted to the attachment device 4, as well as the function as the transmission unit described above.

### Replay Video Replaying Process and Operation Process

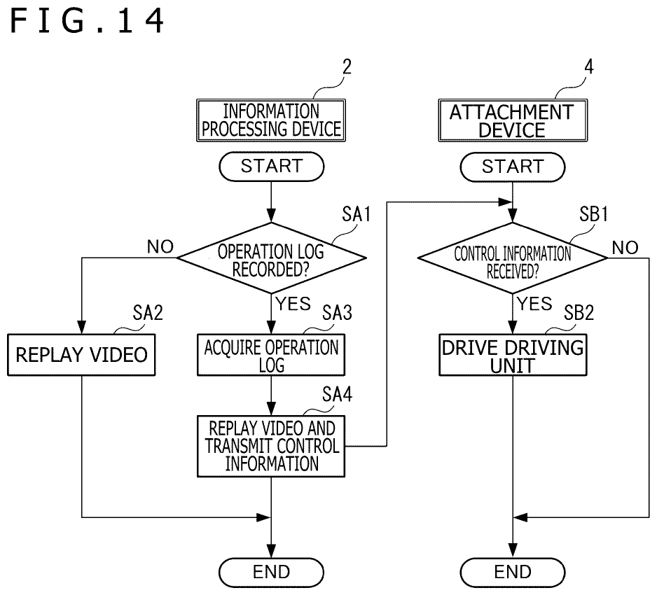

FIG. 14 is a flowchart illustrating a replay video replaying process performed by the information processing device 2, and an operation process performed by the attachment device 4.

As illustrated in FIG. 14, in response to execution of operation for replaying a replay video by the user, the information processing device 2 performs the replay video replaying process, and the attachment device 4 performs the operation process on the basis of control information transmitted from the information processing device 2.

In the replay video replaying process, the replay unit 263 of the information processing device 2 initially determines whether or not an operation log associated with a replay video selected by the user has been recorded in the storage 24 (step SA1).

If it is determined that this operation log has not been recorded in the storage 24 in the determination process in step SA1 (step SA1: NO), the replay unit 263 replays the replay video and outputs the replay video to the display device DS (step SA2). Thereafter, the replay unit 263 ends the replay video replaying process.

If it is determined that the operation log has been recorded in the storage 24 in the determination process in step SA1 (step SA1: YES), the replay unit 263 acquires the operation log associated with the replay video from the storage 24 (step SA3).

Thereafter, the replay unit 263 replays the replay video and outputs the replay video to the display device DS, and also transmits control information associated with the operation log to the attachment device 4 in synchronization with replay of the replay video (step SA4). After replay of the replay video is finished, the replay unit 263 ends the replay video replaying process. Meanwhile, the attachment device 4 executes the operation process.

Specifically, the action control unit 493 determines whether or not the communication unit 47 has received control information from the information processing device 2 (step SB1).

If it is determined that no control information has been received in the determination process in step SB1 (step SB1: NO), the action control unit 493 ends the replay video replaying process.

If it is determined that control information has been received in the determination process in step SB1 (step SB1: YES), the action control unit 493 drives at least one of the first driving unit 42 and the second driving unit 43 according to the received control information to operate at least one of the sticks 37L and 37R constituting the operation members of the controller 3 (step SB2).

Thereafter, the action control unit 493 ends the replay video replaying process when no control information is further received.

Note that a timing for transmitting the control information from the replay unit 263 to the attachment device 4 is not limited to a timing of replay of the replay video. For example, the replay unit 263 may transmit the control information corresponding to the operation log to the attachment device 4 without replaying the replay video.

Moreover, in a case where the user executes a help function during game play, for example, the replay unit 263 transmits control information to the attachment device 4, and also forms an image of a help screen similar to the replay screen RG and displays the image on the display device DS. In this case, while not illustrated in the figure in detail, details of help are displayed in the first display region R1 of the help screen, and an operation method of the controller 3 corresponding to the details of the help is displayed in the second display region R2 of the help screen.

### Application Example

Following functions can be implemented by using the information processing system 1 described above.

In the following description, operation of the operation members provided on the controller 3 by using the attachment device 4 on the basis of control information transmitted from the information processing device 2 to the attachment device 4 will be referred to as remote control.

### First Application Example

According to the information processing system 1 described above, the replay unit 263 of the information processing device 2 replays a play video recorded beforehand, and also transmits operation information to the attachment device 4. Alternatively, the information processing device 2 may acquire an operation log from the server SV or the different information processing device 2A via a network N, and operate the operation members of the controller 3 by using the attachment device 4.

In this case, the replay unit 263 replays a play video associated with another person and acquired from the server SV or the different information processing device 2A, and also remotely controls the controller 3 on the basis of operation information corresponding to the acquired operation log and transmitted to the attachment device 4. In this manner, operation of the controller 3 performed by another user is easily recognizable for the user.

### Second Application Example

According to the information processing system 1 described above, the information processing device 2 can utilize the attachment device 4 for assisting the user.

For example, the information processing device 2 remotely controls the controller 3 to assist operation performed by a user having a disability in one hand, or a user desiring to separate one hand from the controller 3.

Moreover, for example, the information processing device 2 remotely controls the controller 3 according to a progress status of a game to assist progress of the game without notice by the user. For example, in a game which designates one stick 37 of the sticks 37L and 37R as a stock for viewpoint operation, the information processing device 2 remotely controls the designated one stick 37 to operate a viewpoint during execution of the game. In this manner, a strategy clue and notice concerning the game can be given to the user.

### Third Application Example

According to the information processing system 1 described above, the information processing device 2 can communicate with the server SV or the different information processing device 2A via the network N. Accordingly, the user and another user are allowed to play a game by using the same one controller 3.

For example, the user holding the controller 3 operates one stick 37 of the sticks 37L and 37R, while the information processing device 2 remotely controls the other stick 37 of the sticks 37L and 37R according to operation input from the different user to the other stick 37 provided on the different controller 3. In this manner, the same one controller 3 can be operated by both the user and the different user. Accordingly, experiences of novel games are providable.

### Fourth Application Example

According to the information processing system 1 described above, the information processing device 2 remotely controlling the controller 3 according to a progress status of a game can give haptic feedback to the user operating the controller 3.

In this case, in a game which designates one stick 37 of the sticks 37L and 37R as a stick for movement of a player character, for example, the information processing device 2 generates resistance to tilt operation of the designated one stick 37 by remotely controlling the designated one stick 37 according to a game field type where a player character moves. For example, in a case where the game field has a paved road, the information processing device 2 does not produce resistance for the tilt operation. However, in a case where the game field has a marsh, the information processing device 2 produces resistance for the tilt operation. In this manner, more realistic operational feelings can be given to the user.

### Fifth Application Example

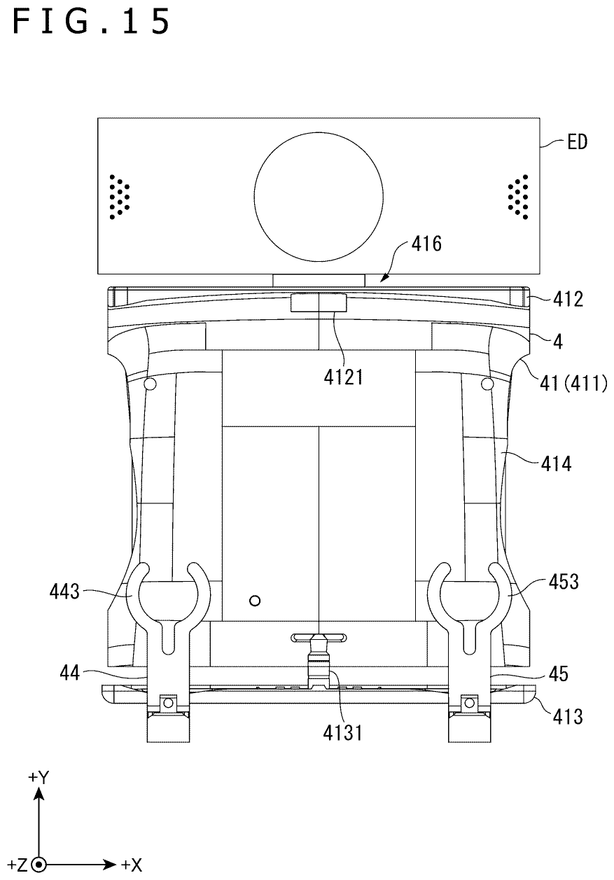

FIG. 15 is a front view illustrating the attachment device 4 to which a function extension device ED is attached.

Functionality of the attachment device 4 can be extended by using the function extension device connected thereto. For example, the function extension device ED can be connected to the attachment device 4 via a connection unit 416 provided on an outside surface of the attachment unit 41 as illustrated in FIG. 15. The function extension device ED illustrated in FIG. 15 is a device which includes a camera and a microphone. In this case, the attachment device 4 transmits images and sounds acquired by the function extension device ED to the information processing device 2.

Note that different examples of the function extension device attachable to the attachment device 4 include a speaker which outputs sounds transmitted from the information processing device 2, an image display device, and a vibration generating device. In these cases, the control unit 49 of the attachment device 4 may process sound signals, image signals, and control signals transmitted from the information processing device 2, and cause the function extension device to output sounds corresponding to the sound signals, images corresponding to the image signals, or vibrations corresponding to the control signals. Alternatively, the function extension device ED may directly communicate with the information processing device 2 to output sounds, images, or vibrations.

### Sixth Application Example

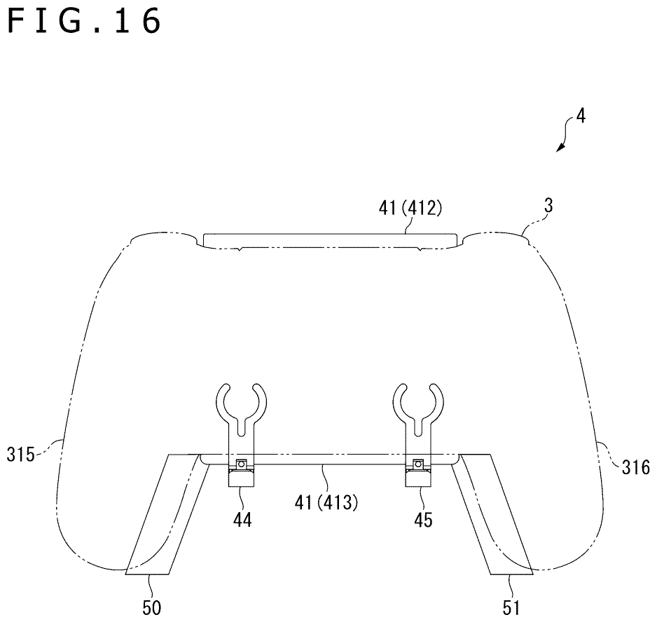

FIG. 16 is a front view illustrating the attachment device 4 to which cover members 50 and 51 are attached. The attachment device 4 is attached to the controller 3. Accordingly, a size and the like of the controller 3 can be customized by attaching additional parts to the attachment device 4.

For example, the left cover member 50 and the right cover member 51 can be attached to the attachment unit 41 of the attachment device 4 as illustrated in FIG. 16.

The left cover member 50 is detachably attached to the attachment unit 41 at a position corresponding to the left grip 315. In this case, at least a part of the left grip 315 is covered by the left cover member 50.

The right cover member 51 is detachably attached to the attachment unit 41 at a position corresponding to the right grip 316. In this case, at least a part of the right grip 316 is covered by the right cover member 51. The left cover member 50 selected from a plurality of types of cover members having different sizes and designs is attached to the attachment device 4. This applies to the right cover member 51.

The attachment device 4 configured as above and attached to the controller 3 enables the user to easily hold the controller 3, thereby enhancing operability of the controller 3.

### Advantageous Effects of First Embodiment

The information processing system 1 according to the present embodiment described above offers following advantageous effects.

The attachment device 4 includes the attachment unit 41, the first driving unit 42, the second driving unit 43, the first arm 44, the second arm 45, and the action control unit 493.

The attachment unit 41 is attached to the controller 3 which includes the sticks 37L and 37R functioning as operation members.

The first arm 44 engages with the first stick 37L, while the second arm 45 engages with the second stick 37R.

The first driving unit 42 moves the first arm 44, while the second driving unit 43 moves the second arm 45.

The action control unit 493 controls the driving units 42 and 43 to operate the sticks 37L and 37R by using the arms 44 and 45, respectively.

According to this configuration, the action control unit 493 causes the driving units 42 and 43 to move the arms 44 and 45 to operate the sticks 37L and 37R of the controller 3. In this case, the sticks 37L and 37R are operated by the attachment device 4 during execution of a help function or replay of a replay video, for example. Accordingly, the user can easily recognize details of necessary operation of the sticks 37L and 37R, and details of operation of the sticks 37L and 37R in a certain scene. In addition, the sticks 37L and 37R are operable by the attachment device 4 in place of the user. Accordingly, the user can be assisted in mastering and performing operation.

The first arm 44 of the attachment device 4 includes the first holding portion 443 for holding the shaft portion 371 of the first stick 37L configured to be tiltable with respect to the controller 3. Similarly, the second arm 45 includes the second holding portion 453 for holding the shaft portion 371 of the second stick 37R configured to be tiltable with respect to the controller 3. The action control unit 493 moves the first arm 44 by using the first driving unit 42, and moves the second arm 45 by using the second driving unit 43.

According to this configuration, the sticks 37L and 37R can be operated by the attachment device 4 according to movement of the arms 44 and 45 by the driving units 42 and 43 under control by the action control unit 493. Moreover, the holding portions 443 and 453 of the arms 44 and 45 hold the shaft portions 371 of the sticks 37L and 37R. Accordingly, the sticks 37L and 37R can be operated by the attachment device 4 without interruption of operation performed by the user for the sticks 37L and 37R.

The attachment unit 41 of the attachment device 4 includes the first spherical portion 4132 and the second spherical portion 4133. Each of the first spherical portion 4132 and the second spherical portion 4133 corresponds to a spherical portion. The first arm 44 has a sliding surface which slides relatively to the first spherical portion 4132 along the first spherical portion 4132. The second arm 45 has a sliding surface which slides relatively to the second spherical portion 4133 along the second spherical portion 4133.

According to this configuration, movement of the respective arms 44 and 45 can be more stabilized than in a case where the respective arms 44 and 45 move in a floating state from the attachment unit 41.

The attachment unit 41 of the attachment device 4 includes the connection terminal 4121 inserted into the recess portion 3131 formed in the controller 3, and also the connection terminal 4131 inserted into the recess portion 3141 formed in the controller 3. Each of the connection terminals 4121 and 4131 corresponds to an insertion portion.

According to this configuration, the connection terminal 4121 is inserted into the recess portion 3131 of the controller 3, while the connection terminal 4131 is inserted into the recess portion 3141. Accordingly, the attachment unit 41, and also the whole attachment device 4 can be attached to the controller 3 in a stable manner.

According to the attachment device 4, the connection terminal 4121 is connected to the terminal 3132 provided on the recess portion 3131, while the connection terminal 4131 is connected to the terminal 3142 provided on the recess portion 3141. Each of the terminals 3132 and 3142 corresponds to a controller side terminal.

According to this configuration, stable attachment between the attachment device 4 and the controller 3, and communication between the attachment device 4 and the controller 3 are achievable by connecting the connection terminals 4121 and 4131 with the terminals 3132 and 3142. Accordingly, usability of the attachment device 4 improves.

The attachment device 4 includes the power source unit 46 which supplies power to the driving units 42 and 43 and the control unit 49. The power source unit 46 can supply power to the controller 3 via the connection terminal 4121 under control by the power source control unit 492. According to this configuration, the attachment device 4 can be used as a battery for supplying power to the controller 3. Accordingly, usability of the attachment device 4 improves.

The attachment device 4 includes the communication unit 47 which communicates, independently of the controller 3, with the information processing device 2 which communicates with the controller 3. The information processing device 2 corresponds to an external device to which the controller 3 transmits operation signals. According to this configuration, the attachment device 4 can communicate with the information processing device 2 independently of a communication state between the controller 3 and the information processing device 2.

The action control unit 493 of the attachment device 4 actuates the driving units 42 and 43 on the basis of control information received by the communication unit 47 from the information processing device 2.

According to this configuration, the sticks 37L and 37R of the controller 3 can be operated on the basis of the control information received from the information processing device 2. Accordingly, remote control of the controller 3 is achievable.

The attachment device 4 includes the left cover member 50 detachably attached to the attachment unit 41 in correspondence with the left grip 315 of the controller 3, and the right cover member 51 detachably attached to the attachment unit 41 in correspondence with the right grip 316.

According to this configuration, thicknesses or the sizes of the grips of the controller 3, for example, can be varied by attaching the cover members 50 and 51 to the attachment unit 41. A plurality of types of the cover members 50 and 51 thus configured are prepared, and the desired cover members 50 and 51 are selected from the plurality of types of the cover members and attached to the attachment unit 41. In this manner, the controller 3 suited for a size of the hands of the user can be formed.

The attachment device 4 includes the connection unit 416 connectable to the function extension device ED for functionality extension.

According to this configuration, the functionality of the attachment device 4 can be extended by connecting the function extension device ED to the connection unit 416. Accordingly, versatility of the attachment device 4 improves.

The information processing system 1 includes the controller 3, the attachment device 4, and the information processing device 2.

The controller 3 includes the sticks 37L and 37R functioning as operation members.

The attachment device 4 is attached to the controller 3. The information processing device 2 controls the attachment device 4. The replay unit 263 of the information processing device 2 has a function of a transmission unit which transmits control information associated with operation of the sticks 37L and 37R to the attachment device 4, and a function of a display control unit which forms images indicating details of operation of the sticks 37L and 37R according to the control information.

According to this configuration, advantageous effects similar to those of the attachment device 4 can be offered.

Moreover, the information processing device 2 operates the sticks 37L and 37R of the controller 3 by using the attachment device 4, and forms images indicating details of operation of the sticks 37L and 37R. In this case, the user can check not only details of operation of the sticks 37L and 37R indicated in the images but also details of operation of the sticks 37L and 37R actually performed by the attachment device 4. Accordingly, the user can easily recognize details of operation of the sticks 37L and 37R.

The attachment device 4 includes the attachment unit 41 attached to the controller 3, the arms 44 and 45 engaging with the sticks 37L and 37R of the controller 3, the driving units 42 and 43 for moving the arms 44 and 45, and the control unit 49 for controlling the driving units 42 and 43. The control unit 49 of the attachment device 4 executes an operation process for actuating the driving units 42 and 43 on the basis of control information according to an operation program stored in the storage unit 48.

Specifically, the attachment device 4 performs a reception procedure by using the communication control unit 491 to receive operation information from the information processing device 2 as an external device, and an operation procedure by using the action control unit 493 to operate the sticks 37L and 37R engaging with the arms 44 and 45 according to actuation of the driving units 42 and 43 on the basis of the received operation information.

According to this configuration, the controller 3 can be remotely controlled by using the attachment device 4 on the basis of the operation information transmitted from the information processing device 2. Accordingly, the user can achieve mastery of operation by using the information processing device 2 for checking details of operation of the controller 3, and can be assisted in performing operation by using the information processing device 2 for operating the controller 3.

### Second Embodiment

Described next will be a second embodiment of the present invention.

An information processing system according to the present embodiment has a configuration similar to the configuration of the information processing system 1 according to the first embodiment. Note herein that operation logs of the controller 3 are recorded by the information processing device 2 in the case of the information processing system 1. Meanwhile, operation logs are also recordable by the attachment device in the case of the information processing system according to the present embodiment. Note that parts described hereinbelow and identical or substantially identical to corresponding parts already discussed will be given identical reference numbers, and will not be repeatedly explained.

### Outline Configuration of Information Processing System

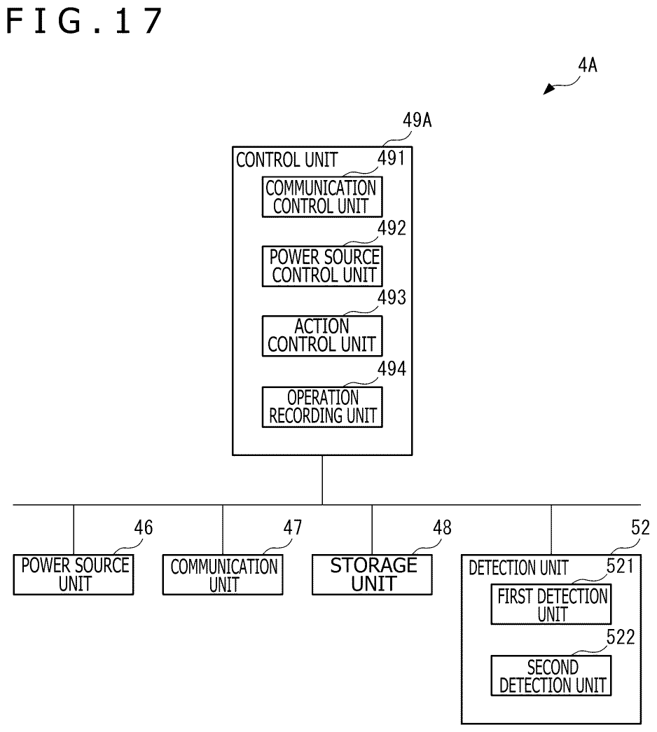

FIG. 17 is a block diagram illustrating a configuration of an attachment device 4A according to the present embodiment.

The information processing system according to the present embodiment has a configuration and functionality similar to those of the information processing system 1 according to the first embodiment except that the attachment device 4A, a part of the configuration of which is illustrated in FIG. 17, is provided instead of the attachment device 4. Specifically, the information processing system according to the present embodiment includes the information processing device 2, the controller 3, and the attachment device 4A.

### Configuration of Attachment Device

The attachment device 4A has a configuration and functionality similar to those of the attachment device 4 according to the first embodiment except that a detection unit 52 and a control unit 49A are provided instead of the control unit 49. Specifically, the attachment device 4A includes the attachment unit 41, the first driving unit 42, the second driving unit 43, the first arm 44, the second arm 45, the power source unit 46, the communication unit 47, the storage unit 48, the control unit 49A, and the detection unit 52. Note that the attachment device 4A may have the left cover member 50 and the right cover member 51.

The detection unit 52 detects actions of the arms 44 and 45 engaging with the operation members provided on the controller 3. Specifically, the detection unit 52 detects a tilt direction and a tilt amount of each of the sticks 37L and 37R engaging with the arms 44 and 45. The detection unit 52 includes a first detection unit 521 and a second detection unit 522.

The first detection unit 521 detects a movement direction and a movement amount of the first arm 44 to detect the tilt direction and the tilt amount of the first stick 37L. Note that the first detection unit 521 may detect a movement direction and a movement amount of the first rack 425, or may detect a rotation direction and a rotation angle of the first motor 421 of the first driving unit 42, and a rotation direction and a rotation angle of the second motor 423.

The second detection unit 522 detects a movement direction and a movement amount of the second arm 45 to detect the tilt direction and the tilt amount of the second stick 37R. Note that the second detection unit 522 may detect a movement direction and a movement amount of the second rack 435, or may detect a rotation direction and a rotation angle of the third motor 431 of the second driving unit 43, and a rotation direction and a rotation angle of the fourth motor 433.

The control unit 49A includes the communication control unit 491, the power source control unit 492, and the action control unit 493 discussed in the first embodiment, and also an operation recording unit 494.

The operation recording unit 494 records operation information indicating movement directions and movement amounts associated with the respective arms 44 and 45 and detected by the detection unit 52. Specifically, the operation recording unit 494 stores in the storage unit 48 a movement direction and a movement amount associated with the first arm 44 and detected by the first detection unit 521, and a movement direction and a movement amount associated with the second arm 45 and detected by the second detection unit 522. In other words, the operation recording unit 494 records an operation log indicating actions of the respective arms 44 and 45. According to the present embodiment, this operation log corresponds to action information.

Note that the operation recording unit 494 records an operation log including details of operation input to the operation members in time series after execution of recording start operation by the user for the attachment device 4A. Alternatively, the operation recording unit 494 records an operation log including details of operation input to the operation members in time series after reception of a recording start signal from the information processing device 2. In other words, the attachment device 4A records an operation log associated with the sticks 37L and 37R.

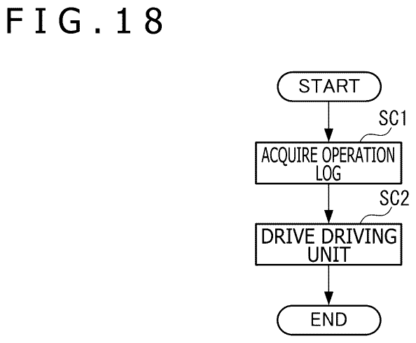

FIG. 18 is a flowchart illustrating an operation process for operating the operation members on the basis of an operation log recorded by the attachment device 4A. According to the present embodiment, the action control unit 493 actuates the respective driving units 42 and 43 according to control information received from the information processing device 2 to operate the operation members of the controller 3.

Moreover, the action control unit 493 executes the operation process illustrated in FIG. 18 in a case where operation for reproducing operation based on an operation log recorded in the storage unit 48 is performed by the user for the attachment device 4A. Note that an operation program implemented by the action control unit 493 to execute the operation process is stored in the storage unit 48. The control unit 49 reads and executes the operation program to achieve the operation process by using the action control unit 493.

Specifically, the action control unit 493 initially acquires an operation log selected by the user from operation logs stored in the storage unit 48 (step SC1). Subsequently, the action control unit 493 drives the driving units 42 and 43 and moves the arms 44 and 45 on the basis of the acquired operation log to operate the sticks 37L and 37R constituting operation members (step SC2).

Thereafter, when driving of the driving units 42 and 43 ends according to the operation log, the action control unit 493 ends the operation process.

In this manner, the attachment device 4A can reproduce operation performed by the user for the controller 3 without using the information processing device 2.

### Advantageous Effects of Second Embodiment

The information processing system according to the present embodiment described above offers advantageous effects similar to those of the first embodiment, and further produces following advantageous effects.

The attachment device 4A includes the detection unit 52 and the storage unit 48.

The detection unit 52 detects actions of the arms 44 and 45.

The storage unit 48 stores an operation log indicating actions associated with the arms 44 and 45 and detected by the detection unit 52. This operation log corresponds to action information.

According to this configuration, the attachment device 4 can record an operation log of the sticks 37L and 37R constituting operation members of the controller 3.

The action control unit 493 of the attachment device 4A actuates the driving units 42 and 43 on the basis of the operation log stored in the storage unit 48.

According to this configuration, the attachment device 4A can reproduce operation previously performed by the user for the sticks 37L and 37R on the basis of the operation log recorded in the storage unit 48.

In addition, for achieving synchronization between the action of the attachment device 4A based on the operation log recorded beforehand and image display by the information processing device 2, for example, the information processing device 2 may transmit synchronous signals to the attachment device 4A. In this case, the attachment device 4A carries out operation of the operation members according to the synchronous signals on the basis of the operation log. In this manner, synchronization is achievable between image display by the information processing device 2 with use of the display device DS and operation of the attachment device 4A for the operation members provided on the controller 3. These synchronous signals may be transmitted for each timing of operation of the operation members, or may be transmitted only at the time of an operation start by the attachment device 4A according to the operation log.

The attachment device 4A includes the attachment unit 41 attached to the controller 3 which includes the sticks 37L and 37R corresponding to operation members, the arms 44 and 45 engaging with the sticks 37L and 37R, the driving units 42 and 43 for moving the arms 44 and 45, and the control unit 49A for controlling the driving units 42 and 43. The control unit 49A of the attachment device 4A executes an operation process for actuating the driving units 42 and 43 on the basis of control information according to an operation program stored in the storage unit 48.

In the operation process, the attachment device 4A carries out the step SC1 which reads from the storage unit 48 an operation log indicating details of operation of the sticks 37L and 37R and stored in the storage unit 48 beforehand, and the step SC2 which actuates the driving units 42 and 43 on the basis of the read operation log to operate the sticks 37L and 37R engaging with the arms 44 and 45. The step SC1 corresponds to a reading procedure, the step SC2 corresponds to an operation procedure, and the operation log corresponds to operation information.

According to this configuration, operation of the controller 3 can be reproduced by the attachment device 4A on the basis of the operation log stored in the storage unit 48. Accordingly, previous operation performed for the controller 3 can be reproduced. In this case, a check of previous operation performed by the user can be made, for example. Accordingly, on the basis of this checking, the user can be assisted in mastering operation, and the previous operation performed by the user can be repeatedly executed by using the attachment device 4A.

### Modifications of Embodiments

It is not intended that the present invention be limited by the respective embodiments presented above. The present disclosure includes any modifications, improvements, and others made within the scope where the object of the present invention is achievable.

According to the respective embodiments described above, each of the attachment devices 4 and 4A includes the communication unit 47 which communicates with the information processing device 2 independently of the controller 3. However, instead of this configuration, in a case where the communication unit 47 is connected to the controller 3 via the connection terminal 4121 or 4131, the communication unit 47 may communicate, via the controller 3, with the information processing device 2 communicating with the controller 3.

In this case, the configuration for connecting the attachment device 4 or 4A with the information processing device 2 can be simplified. In addition, at least a part of settings for connecting the attachment device 4 or 4A with the information processing device 2 may be eliminated.

According to the respective embodiments described above, each of the attachment devices 4 and 4A is configured to operate the sticks 37L and 37R included in the operation members of the controller 3 and tiltable with respect to the front portion 312. However, instead of this configuration, the operation members operable by the attachment device may be other types of operation members. For example, the attachment device may be configured to operate at least any one of the buttons 33 to 35.

According to the respective embodiments described above, the first pinching portion 412 and the second pinching portion 413 included in the attachment unit 41 pinch the controller 3 in the +Y direction and the −Y direction. However, instead of this configuration, the attachment unit 41 may pinch the controller 3 in the +X direction and the −X direction, or in the +Z direction and the −Z direction. Moreover, the attachment mode of each of the attachment devices 4 and 4A to the controller 3 may be appropriately varied as long as the attachment device 4 or 4A is attachable to the controller 3.

According to the respective embodiments described above, each of the attachment devices 4 and 4A includes the first arm 44 engaging with the first stick 37L, the second arm 45 engaging with the second stick 37R, the first driving unit 42 for moving the first arm 44, and the second driving unit 43 for moving the second arm 45. However, instead of this configuration, each of the attachment devices 4 and 4A may include either the set of the first driving unit 42 and the second arm 44 or the set of the second driving unit 43 and the second arm 45.

According to the respective embodiments described above, the first driving unit 42 includes the first motor 421 for moving the first arm 44 along the X axis, and the second motor 423 for moving the first arm 44 along the Y axis. However, instead of this configuration, the first driving unit 42 may include only either the first motor 421 or the second motor 423. This applies to the second driving unit 43 including the third motor 431 and the fourth motor 433.

According to the respective embodiments described above, the first arm 44 includes the first holding portion 443 which holds the shaft portion 371 of the first stick 37L, and the second arm 45 includes the second holding portion 453 which holds the shaft portion 371 of the second stick 37R. However, instead of this configuration, the first holding portion 443 may be eliminated if the first arm 44 can operate the first stick 37L. This applies to the second arm 45.

According to the respective embodiments described above, the attachment unit 41 includes the first spherical portion 4132 and the second spherical portion 4133 both included in the second pinching portion 413. The first arm 44 includes a sliding surface which is a surface inside the first recess portion 4411 and slides relatively to the first spherical portion 4132 along the first spherical portion 4132. The second arm 45 includes a sliding surface which is a surface inside the second recess portion 4511 and slides relatively to the second spherical portion 4133 along the second spherical portion 4133. However, instead of this configuration, the first arm 44 may have a first spherical portion, the second arm 45 may have a second spherical portion, and the attachment unit may have a sliding surface in contact with the first spherical portion and a sliding surface in contact with the second spherical portion.

According to the respective embodiments described above, the first arm 44 swings around a fulcrum located at the first spherical portion 4132 according to movement of the first rack 425 along the X axis and the Y axis by the first motor 421 and the second motor 423. The second arm 45 swings around a fulcrum located at the second spherical portion 4133 according to movement of the second rack 435 along the X axis and the Y axis by the third motor 431 and the fourth motor 433. However, instead of this configuration, the first spherical portion 4132 may be eliminated, and the first arm 44 may be moved together with the first rack 425 as one body. This applies to the second arm 45.

According to the respective embodiments described above, each of the attachment devices 4 and 4A includes the connection terminal 4121 inserted into the recess portion 3131 of the controller 3, and includes the connection terminal 4131 inserted into the recess portion 3141 of the controller 3. However, instead of this configuration, the insertion portion included in each of the attachment devices 4 and 4A and inserted into the controller 3 may be eliminated. Even in a case where each of the attachment devices 4 and 4A has the insertion portion, the recess portion formed in the controller 3 to receive the insertion portion is not required to be a recess where a terminal is provided.

Moreover, the controller 3 may have only either the recess portion 3131 or the recess portion 3141.

According to the respective embodiments described above, the power source unit 46 can supply power to the controller 3 via the connection terminal 4121. However, instead of this configuration, the power source unit 46 is not required to supply power to the controller 3. Moreover, even in a case where power is supplied from the power source unit 46, this power may be supplied to the controller 3 by using a terminal other than the connection terminal 4121.

Meanwhile, in a case where the controller 3 is connected with the information processing device 2 by wire, in a case where the controller 3 is connected with an external power source, or in other cases, each of the attachment devices 4 and 4A may be actuated by power supplied from the controller 3.

Moreover, in a case where each of the attachment devices 4 and 4A is connected with the information processing device 2 by wire, each of the attachment devices 4 and 4A may be driven by power supplied from the information processing device 2. Further, in the case where each of the attachment devices 4 and 4A is connected with the information processing device 2 by wire, each of the attachment devices 4 and 4A may communicate with the information processing device 2 by wire.

According to the respective embodiments described above, the operation program executed by each of the control units 49 and 49A is stored in the storage unit 48. However, instead of this configuration, the operation program may be recorded in a recording medium, and each of the control units 49 and 49A may read the operation program from the recording medium and execute the operation program. Examples of this recording medium include a tape recording medium, a disk recording medium, and a semiconductor memory. In addition, each of the control units 49 and 49A may acquire the operation program from a device provided in the network N, and execute the acquired operation program.

### Summary of the Invention

A following additional note is a summary of the present invention.
[1] An attachment device including:
an attachment unit attached to a controller that includes
an operation member;
an arm that engages with the operation member;
a driving unit that moves the arm; and
an action control unit that causes the driving unit to drive the arm to operate the operation member.

According to this configuration, the action control unit causes the driving unit to move the arm to allow the operation member of the controller to be operated. In this case, the operation member is operated by the attachment device during execution of a help function or replay of a replay video, for example. Accordingly, the user can easily recognize details of operation of the operation member in a certain scene. In addition, the operation member is operable by the attachment device in place of the user. Accordingly, the user can be assisted in mastering and performing operation.
[2] The attachment device according to [1], in which
the arm includes a holding portion that holds a shaft portion of the operation member configured to be tiltable with respect to the controller, and
the action control unit causes the driving unit to move the arm.

According to this configuration, the driving unit moves the arm under control by the action control unit to allow the attachment device to operate the operation member. Moreover, the holding portion of the arm holds the shaft portion of the operation member. Accordingly, the attachment device can operate the operation member without interruption of operation input to the operation member by the user.
[3] The attachment device according to [1] or [2], in which
one of the attachment unit and the arm includes a spherical portion, and
another of the attachment unit and the arm includes a sliding surface that slides relatively to the spherical portion along the spherical portion.

According to this configuration, movement of the arm can be more stabilized than in a case where the arm moves in a floating state from the attachment unit.
[4] The attachment device according to any one of [1] to [3], in which the attachment unit includes an insertion portion inserted into a recess portion formed in the controller.

According to this configuration, the insertion portion is inserted into the recess portion of the controller. In this manner, the attachment unit, and also the whole attachment device can be attached to the controller in a stable manner.
[5] The attachment device according to [4], in which the insertion portion is a connection terminal connected to a controller side terminal provided on the recess portion. According to this configuration, stable attachment between the attachment device and the controller and communication between the attachment device and the controller are achievable by connecting the connection terminal with the controller side terminal. Accordingly, usability of the attachment device improves.
[6] The attachment device according to [5], further including:
a power source unit that supplies power to the driving unit and the action control unit, in which
the power source unit is configured to supply power to the controller via the connection terminal.

According to this configuration, the attachment device is available as a battery for supplying power to the controller. Accordingly, usability of the attachment device improves.
[7] The attachment device according to [5] or [6], further including:
a communication unit that communicates, via the controller, with an external device that communicates with the controller.

This configuration can simplify the configuration for connecting the attachment device with the external device, and eliminate at least a part of settings for connecting the attachment device with the external device.
[8] The attachment device according to any one of [1] to [6], further including:
a communication unit that communicates, independently of the controller, with an external device that communicates with the controller.

According to this configuration, the attachment device can communicate with the external device independently of a communication state between the controller and the external device.
[9] The attachment device according to [7] or [8], in which
the action control unit actuates the driving unit on the basis of control information received by the communication unit from the external device.

According to this configuration, the operation member of the controller can be operated on the basis of the control information received from the external device. Accordingly, remote control of the controller is achievable.
[10] The attachment device according to any one of [1] to [9], further including:
a detection unit that detects an action of the arm; and
a storage unit that stores action information indicating the action performed by the arm and detected by the detection unit.

According to this configuration, the attachment device can record an operation log associated with the operation member of the controller.
[11] The attachment device according to [10], in which the action control unit actuates the driving unit on the basis of the action information stored in the storage unit.

According to this configuration, the attachment device can reproduce operation previously performed by the user for the operation member on the basis of an operation log recorded in the storage unit.
[12] The attachment device according to any one of [1] to [11], further including:
a cover member detachably attached to the attachment unit in correspondence with a grip of the controller.

According to this configuration, a thickness or a size of the grip, for example, can be varied by attaching the cover member to the attachment unit. A plurality of types of the cover members thus configured are prepared, and the desired cover member is selected from the plurality of types of the cover members and attached to the attachment unit. In this manner, the controller suited for the size of the hand of the user can be formed.
[13] The attachment device according to any one of [1] to [12], further including:
a connection unit connectable to a function extension device for extending functionality.

According to this configuration, the functionality of the attachment device can be extended by connecting the function extension device to the connection unit. Accordingly, versatility of the attachment device improves.
[14] An information processing system including:
a controller that includes an operation member;
an attachment device according to any one of [1] to [13] attached to the controller; and
an information processing device that controls the attachment device, in which
the information processing device includes
a transmission unit that transmits operation information associated with operation of the operation member to the attachment device, and
a display control unit that forms an image indicating details of operation performed for the operation member on the basis of the operation information.

According to this configuration, advantageous effects similar to those of the attachment device described above can be offered.

In addition, the information processing device operates the operation member of the controller by using the attachment device, and forms an image indicating details of operation of the operation member. In this manner, the user can check details of operation practically performed by the attachment device for the operation member as well as the details of the operation indicated in the image. Accordingly, the user can easily recognize the details of the operation of the operation member.
[15] An operation method performed by an attachment device to operate an operation member, the attachment device including an attachment unit attached to a controller including the operation member, an arm that engages with the operation member, and a driving unit that moves the arm, the method including:
a reception procedure of receiving operation information from an external device; and
an operation procedure of actuating the driving unit on the basis of the received operation information to operate the operation member engaging with the arm. According to this configuration, the controller can be remotely controlled by the attachment device on the basis of the operation information transmitted from the external device. Accordingly, the user can master operation by checking details of operation performed by the external device for the controller. In addition, the user can be assisted in operation by using the external device for operating the controller.
[16] An operation method performed by an attachment device to operate an operation member, the attachment device including an attachment unit attached to a controller including the operation member, an arm that engages with the operation member, and a driving unit that moves the arm, the method including:
a reading procedure of reading, from a storage unit, operation information that indicates details of operation of the operation member and is stored in the storage unit beforehand; and
an operation procedure of actuating the driving unit on the basis of the read operation information to operate the operation member engaging with the arm.

According to this configuration, the attachment device can reproduce operation of the controller on the basis of the operation information stored in the storage unit. In this case, previous operation performed for the controller can be reproduced. Accordingly, the user can be assisted in mastering operation by checking previous operation performed by the user, for example.
[17] An operation program executed by a control unit of an attachment device to operate an operation member, the attachment device including an attachment unit attached to a controller including the operation member, an arm that engages with the operation member, a driving unit that moves the arm, and the control unit that controls the driving unit, the operation program causing the control unit to execute:
a reception step of receiving operation information from an external device; and
an operation step of actuating the driving unit on the basis of the received operation information to operate the operation member engaging with the arm.

According to this configuration, similarly to the operation method described above, the user can master operation by using the external device for remotely control of the controller, and can be assisted in operation by using the external device for operation of the controller.
[18] An operation program executed by a control unit of an attachment device to operate an operation member, the attachment device including an attachment unit attached to a controller including the operation member, an arm that engages with the operation member, a driving unit that moves the arm, and the control unit that controls the driving unit, the operation program causing the control unit to execute:
a read step of reading, from a storage unit, operation information that indicates details of operation of the operation member and is stored in the storage unit beforehand; and
an operation step of actuating the driving unit on the basis of the read operation information to operate the operation member engaging with the arm.

According to this configuration, similarly to the operation method described above, the user can be assisted in mastering operation by checking previous operation performed by the user, for example.

### REFERENCE SIGNS LIST

1: Information processing system
2: Information processing device
263: Replay unit (transmission unit, display control unit)
3: Controller
3131: Recess portion
3132: Terminal (controller side terminal)
3141: Recess portion
3142: Terminal (controller side terminal)
315: Left grip (grip)
316: Right grip (grip)
37: Stick (operation member)
37L: First stick (operation member)
37R: Second stick (operation member)
4, 4A: Attachment device
41: Attachment unit
411: First housing
412: First pinching portion
4121: Connection terminal
413: Second pinching portion
4131: Connection terminal
4132: First spherical portion
4133: Second spherical portion
414: Support portion
415: Second housing
416: Connection unit
42: First driving unit
421: First motor
422: First pinion
423: Second motor
424: Second pinion
425: First rack
43: Second driving unit
431: Third motor
432: Third pinion
433: Fourth motor
434: Fourth pinion
435: Second rack
44: First arm
441: First extending portion
4411: First recess portion
442: Second extending portion
443: First holding portion
45: Second arm
451: Third extending portion
4511: Second recess portion
452: Fourth extending portion
453: Second holding portion
46: Power source unit
47: Communication unit
48: Storage unit
49, 49A: Control unit
491: Communication control unit
492: Power source control unit
493: Action control unit
494: Operation recording unit
50: Left cover member (cover member)
51: Right cover member (cover member)
52: Detection unit
521: First detection unit
522: Second detection unit
ED: Function extension device

1. An attachment device comprising:
an attachment unit attached to a controller that includes an operation member;
an arm engaged with the operation member;
a driving unit configured to move the arm; and
an action control unit configured to cause the driving unit to drive the arm to operate the operation member.

2. The attachment device according to claim 1, wherein
the arm includes a holding portion that holds a shaft portion of the operation member configured to be tiltable with respect to the controller, and
the action control unit is configured to cause the driving unit to move the arm.

3. The attachment device according to claim 1, wherein one of the attachment unit and the arm includes a spherical portion, and
another of the attachment unit and the arm includes a sliding surface that slides relatively to the spherical portion along the spherical portion.

4. The attachment device according to claim 1, wherein the attachment unit includes an insertion portion inserted into a recess portion formed in the controller.

5. The attachment device according to claim 4, wherein the insertion portion is a connection terminal connected to a controller side terminal provided on the recess portion.

6. The attachment device according to claim 5, further comprising:
a power source unit configured to supply power to the driving unit and the action control unit, wherein
the power source unit is configured to supply power to the controller via the connection terminal.

7. The attachment device according to claim 5, further comprising:
a communication unit configured to communicate, via the controller, with an external device configured to communicate with the controller.

8. The attachment device according to claim 1, further comprising:
a communication unit configured to communicate, independently of the controller, with an external device configured to communicate with the controller.

9. The attachment device according to claim 7, wherein the action control unit is configured to actuate the driving unit on a basis of control information received by the communication unit from the external device.

10. The attachment device according to claim 1, further comprising:
a detection unit configured to detect an action of the arm; and
a storage unit configured to store action information indicating the action performed by the arm and detected by the detection unit.

11. The attachment device according to claim 10, wherein the action control unit is configured to actuate the driving unit on a basis of the action information stored in the storage unit.

12. The attachment device according to claim 1, further comprising:
a cover member detachably attached to the attachment unit in correspondence with a grip of the controller.

13. The attachment device according to claim 1, further comprising:
a connection unit connectable to a function extension device for extending functionality.

14. An information processing system comprising:
a controller that includes an operation member;
an attachment device comprising:
an attachment unit attached to the controller,
an arm engaged with the operation member,
a driving unit configured to move the arm, and
an action control unit configured to cause the driving unit to drive the arm to operate the operation member,
and
an information processing device configured to control the attachment device, wherein the information processing device includes
a transmission unit configured to transmit operation information associated with operation of the operation member to the attachment device, and
a display control unit configured to form an image indicating details of operation performed for the operation member on a basis of the operation information.

15. An operation method performed by an attachment device to operate an operation member, the attachment device including an attachment unit attached to a controller including the operation member, an arm that engages with the operation member, and a driving unit that moves the arm, the method comprising:
receiving operation information from an external device or reading, from a storage unit, operation information that indicates details of operation of the operation member and is stored in the storage unit beforehand; and
actuating the driving unit on a basis of the received operation information to operate the operation member engaging with the arm.

16. (canceled)

17. A non-transitory computer readable medium storing an operation program executable by a control unit of an attachment device to operate an operation member, the attachment device including an attachment unit attached to a controller including the operation member, an arm engaged with the operation member, a driving unit configured to move the arm, and the control unit configured to control the driving unit, and cause the control unit to execute the operation method of claim 15.

18. (canceled)
